(19) United States
(12) Patent Application Publication
(10) Pub. No.: US 2005/0099831 A1
(43) Pub. Date: May 12, 2005

(54) Switch-capacitor regulated boot converter and inverter

(76) Inventors: Henry Wong, Sunnyvale, CA (US); Raymond Chow, Sunnyvale, CA (US)

Correspondence Address: LAW OFFICES OF CLEMENT CHENG, 17220 NEWHOPE STREET #127, FOUNTAIN VALLEY, CA, 92708, US

(21) Appl. No.: 10/705,588

(22) Filed: Nov. 10, 2003

(51) Int. Cl. H02M 3/18

(52) U.S. Cl. 363/60

(57) ABSTRACT

Methods and apparatus are presented which converts a DC voltage into both a regulated boost voltage and a regulated inverter by means of switch-capacitors with feedback. Methods and apparatus may be fabricated as an integrated circuit, and/or may be fabricated with one and/or multiple communication line transceivers on a single silicon substrate.

### FIELD OF INVENTION

The present invention relates generally to the field of voltage conversion, and particular to a regulated voltage boost (step-up) and a regulated inverter DC to DC converter, that executes the bi-polar voltage conversions by means of switching capacitors.

### DISCUSSION OF RELATED ART

Most electronic components require at least one single power source such as batteries to power up its circuitries. Within a system, a large number of electronic components perform different functions that might require different power supply voltages to reduce overall system power consumption. DC to DC converters have long provided different voltages for different groups of electronic components. For example, in a computer system, the data communication might require two differential voltages to optimize performance and maximize transmission distance.

In general, DC to DC conversion can be classified into either boost (step-up) converter, in which the input voltage will be stepped-up to an output voltage that is higher than its input voltage, or buck (step-down) converter, in which the input voltage will be stepped-down to an output voltage that is lower than its input voltage. Depending on electrical requirements, converters can be implemented by means of an external inductor coil, or by some external capacitors. DC to DC conversion can be implemented in integrated circuits by a wide variety of commonly available means.

For example, U.S. Patent (U.S. Pat. No. 5,649,210) assigned to Maxim discloses a charge pump having all MOS transistors as switching elements to generate both boost and buck voltages. Unfortunately, its amplitude of buck voltages always falls short of its amplitude of boost voltage, compromising the buck voltage over the boost voltage.

Also, U.S. Patent to Chan (U.S. Pat. No. 5,306,954) discloses a charge pump using all MOS transistors as switching elements and four phases of shifting, but this device suffers from power inefficiency.

### OBJECTS OF THE INVENTION

The present invention relates to a voltage converter that generates both higher than input voltage (boost) and regulated inverter voltage, by means of external capacitors. The amplitude of the regulated inverter voltage is even higher than the boost voltage so as to optimize the performance of the switching capacitors and improve the overall power efficiency. Since stability of the generated voltages, either boost voltage or inverter voltage, is critical to the functionality and reliability of electronic components, the present invention provides a mean of regulating both the boost and the inverter voltages to achieve compliant voltage levels when used in data communication line drivers and receivers regardless of power supply fluctuations.

### SUMMARY OF THE INVENTION

Methods and apparatus are presented which converts a DC voltage into both a regulated boost voltage and a regulated Inverter by means of switch-capacitors. When used with data communication line drivers and receivers, it provides true compliant voltage levels regardless of power supply fluctuation, and provides a better power efficiency and super low power consumption. Embodiments for this bi-polar voltages generation, regulation, and implementation are disclosed.

### BRIEF DESCRIPTION OF THE DRAWINGS

FIG. 1 is a block diagram illustrating a preferred embodiment of a switch-capacitor regulated boost converter and inverter in accordance with the invention.

FIG. 2 is a schematic drawing illustrating a preferred embodiment of switching capacitors going through two clock phase-shifting in accordance with the invention.

FIG. 3 is a schematic diagram illustrating a preferred embodiment of circuit implementation of switching capacitors in accordance with the invention.

FIG. 4 is a block diagram illustrating a preferred embodiment of an intelligent bi-directional switch symbol in accordance with FIG. 3.

FIG. 5 is a schematic diagram illustrating a preferred embodiment of circuit implementation in accordance with FIG. 4.

FIG. 6 is a schematic drawing illustrating a preferred embodiment of an equivalence in accordance with FIG. 5.

FIG. 7 is a block diagram illustrating a preferred embodiment of voltage regulation in accordance with the invention.

### DETAILED DESCRIPTION OF THE INVENTION

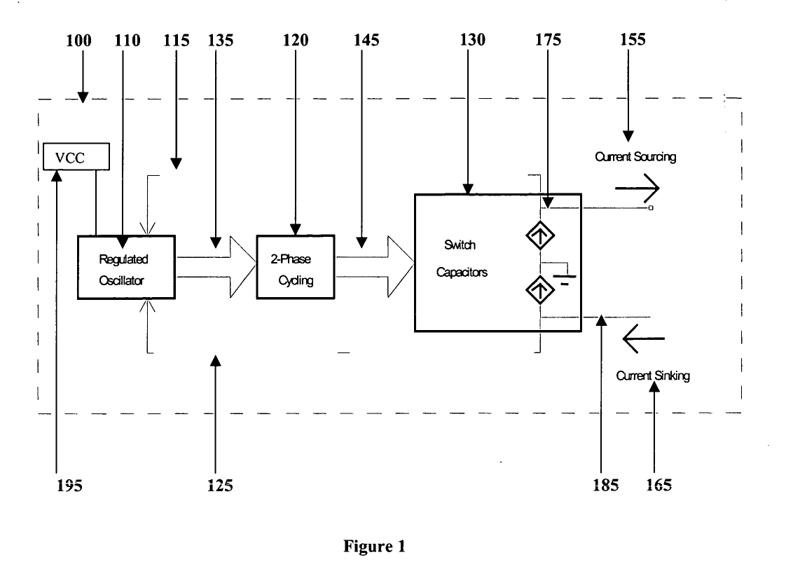

Referring to FIG. 1, an embodiment of a switch-capacitor regulated boost converter and Inverter block 100 of the invention is illustrated. In the embodiment shown, the converter block 100 consists of a regulated oscillator block 110, a 2-phase cycling block 120, and a switch capacitors block 130. It is possible to integrate the converter block 100 with other electronics in a single substrate silicon, for example, data communication line drivers and receivers such as EIA-232.

In one embodiment, the regulated oscillator block 110 provides a pre-determined oscillation frequency to the 2-phase cycling block 120, such that its oscillation frequency 135 is in response to the boosted voltage level feedback 115 and the inverted voltage level feedback 125. The oscillation frequency 135 output from the regulated oscillator block 110 becomes the input of the 2-phase cycling block 120. The 2-phase cycling block 120 exhibits a repetitive two phases of oscillation and output a set of control signals 145 to control the switching of capacitors in the switch capacitors block 130. The switch capacitor block 130 provides a mean of current sourcing 155 with a boosted voltage level 175, and a mean of current sinking 165 with an inverted voltage level 185. The converter block 100 takes in a range input voltages 195, and boost up an output voltage 175 capable of sourcing a pre-determined amount of current 155, and an inverter output voltage 185 capable of sinking a pre-determined amount of current 165. For example, the input voltage 195 can range from 3.0V to 5.5V, the boosted output voltage 175 is at +5.4V capable of sourcing a pre-determined amount of current to ground, and the regulated inverter output voltage 185 is at −5.6V capable of sinking a pre-determined amount of current to ground. The amount of source or sink current is inter-related to the oscillation frequency, switch capacitor capacity and their respective controlling switches and devices.

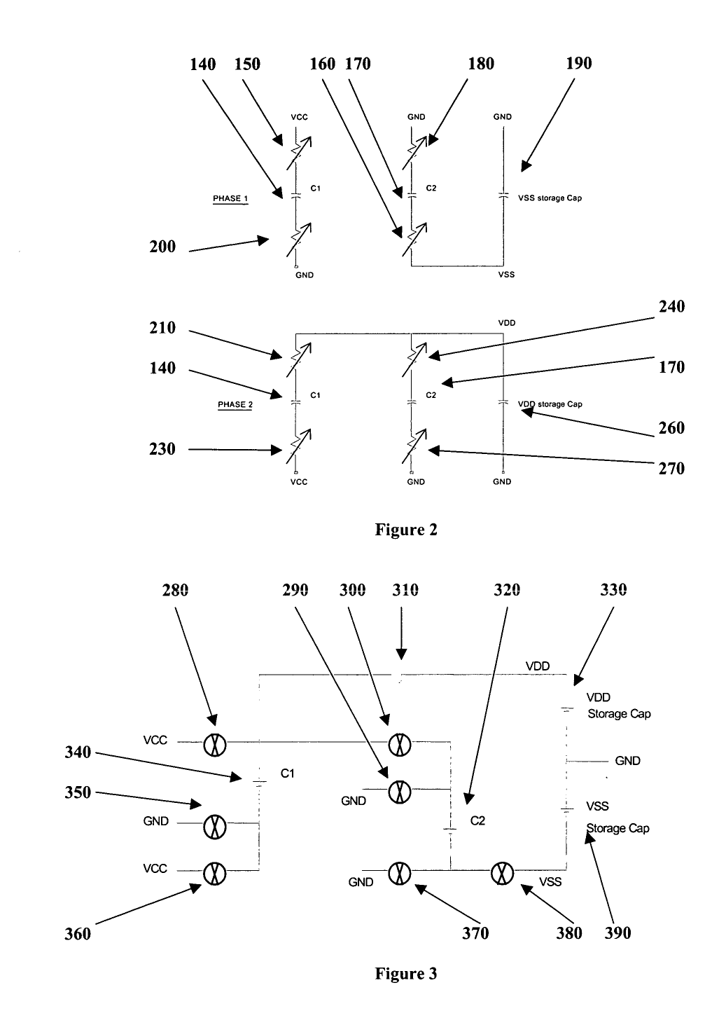

FIG. 2 shows an embodiment of the switching capacitors block in two clock phase-shifting in accordance with the invention. In the embodiment shown, during phase 1, one of the terminals of the switch capacitor 140 is connected to the supply voltage VCC through a switching device 150, while the other terminal of the switch capacitor 140 is connected to Ground through a switching device 200. This connectivity allows the switching capacitor 140 to accumulate charges with an electric potential in equivalence to VCC. One of the terminals of the switch capacitor 170 is connected to Ground through a switching device 180, while the other terminal of the switch capacitor 170 is connected to VSS through a switching device 160. VSS is an electric potential more negative than Ground and its charges are stored by a VSS storage capacitor 190. This connectivity allows charges accumulated on the switching capacitor 170 be transferred onto the VSS storage capacitor 190.

In phase 2, one of the terminals of the switch capacitor 140 is now connected to VDD through a switching device 210. VDD is an electric potential more positive than VCC and its charges are stored by a VDD storage capacitor 260. The other terminal of the switching capacitor 140 is connected to VCC through a switching device 230. At the same time, one of the terminals of the switch capacitor 170 is also connected to VDD through a switching device 240, while the other terminal of the switching capacitor 170 is connected to Ground through a switching device 270. This connectivity allows charges accumulated on switching capacitor 140 be transferred onto both the switching capacitor 170 and VDD storage capacitor 260.

These two phases of shifting continues on to allow charges be accumulated and transferred to VDD and VSS storage capacitors alternately.

Referring to FIG. 3, an embodiment of circuit implementation of the switching capacitors in accordance with the invention is illustrated. The switching devices described previously are represented here as 280, 350, 360, 310, 300, 290, 370, and 380. The switching device 310 in the figure is drawn as a passive diode, and can be also implemented as a switching device. The switching capacitors 340 and 320, as well as the VDD storage capacitor 330 and the VSS storage capacitor 390 can be implemented using discrete components. Size of these capacitors is also related to the amount of source or sink current that VDD or VSS can provide, respectively.

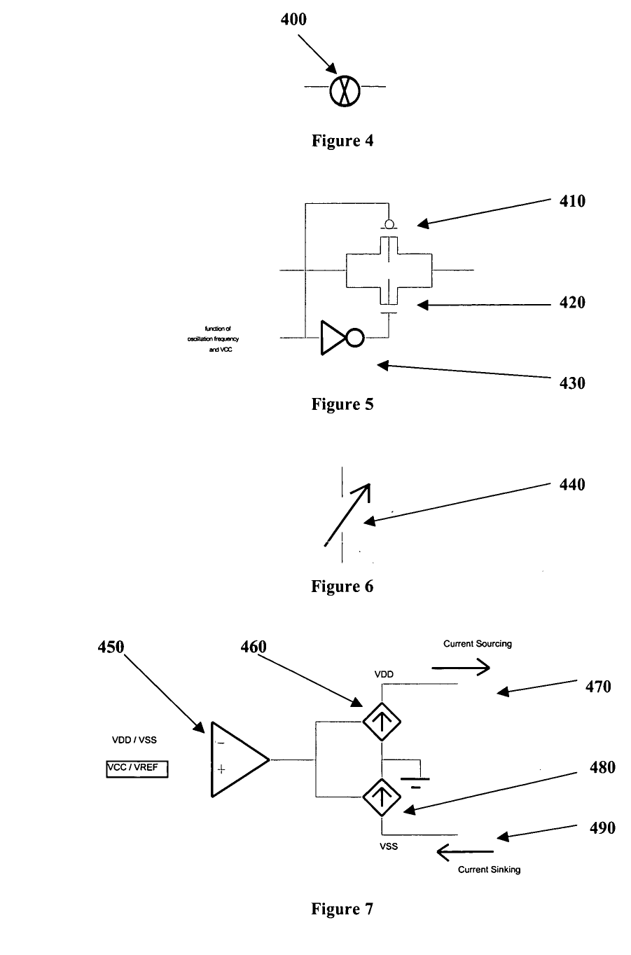

In FIG. 4, a block diagram illustrating a preferred embodiment of a symbol in accordance with FIG. 3 is shown. The circuit implementation in accordance with FIG. 4 is illustrated in FIG. 5, with its equivalence illustrated in FIG. 6. The switching device symbol 400 can be unidirectional such as a passive diode, or can be bidirectional as implemented in FIG. 5. In FIG. 5, the PMOS 410 and NMOS 420, together forms a transmission gate, in which an inverter 430 controls its conduction in either direction. The amount of charges allow to go through this switching device 400 can be controlled by the oscillation frequency, VCC, or other logical operation. This variation of charges conduction can be modeled as a variable resistor 440, as illustrated in FIG. 6.

Referring to FIG. 7, an embodiment of voltage regulation in accordance with the invention is illustrated. Both the VDD and VSS voltage level are compared with a reference voltage level to determine if VDD or VSS voltage level reaches the pre-determined level. In an alternative embodiment, the actual amount of the source current and sink current can be compared with the reference voltage through some resistance.

The comparing function 450 outputs a voltage level to control the current sourcing source 460, which in turns regulates both the VDD voltage level and the amount of source current 470. The comparing function 450 also outputs a voltage level to control the current sinking source 480, which in turns regulates both the VSS voltage level and the amount of sink current 490.

Call Out List

100 Inverter Block

110 Regulated Oscillator Block

120 Two-Phase Cycling Block

130 Switch Capacitors Block

135 Oscillation Frequency

115 Boosted voltage Level Feedback

125 Inverted Voltage Level Feedback

145 Control Signals

155 Current Sourcing

165 Current Sinking

140 170 Switch Capacitors

150 160 180 200 Switching Devices

175 Boosted Voltage Level

185 Inverted Voltage Level

190 VSS Storage Capacitor

195 Input Voltages

210 230 240 270 Switching Device

260 VDD Storage Capacitor

280 290 300 310 350 360 370 380 Switching Devices

320 340 Switching Capacitors

330 VDD Storage Capacitor

390 VSS Storage Capacitor

400 Switching Device Symbol

410 PMOS

420 NMOS

430 Inverter

440 Variable Resistor

450 Comparing Function

460 470 Current Source

480 Current Sinking Source

490 Sinking Current

1. A circuit for providing a DC bipolar output voltage from an fixed DC unipolar input supply source comprising:
a regulated oscillator block providing a predetermined oscillation frequency, wherein the oscillation frequency is in response to a boosted voltage level feedback;
a dual phase cycling block receiving the predetermined oscillation frequency, wherein the dual phase cycling block outputs a set of controls signals;
a switch capacitor block receiving control signals from the dual phase cycling block to control the switching of capacitors in a switch capacitor, wherein the switch capacitor block provides a means of current sourcing having a boosted voltage level that is routed to the boosted voltage level feedback for the regulated oscillator block, and wherein the switch capacitor block provides a means of current sinking with an inverted voltage level, wherein the amount of source or sink current is interrelated to the oscillation frequency, switched capacitor capacity and their respective controlling switches and devices.

2. The apparatus in claim 1 wherein the device is integrated with other electronics in a single silicon substrate.

3. The apparatus in claim 1 wherein the dual phase cycling block alternately charges a pair of storage capacitors VCC and VSS.

4. The apparatus in claim 1 wherein the VDD and VSS voltage level are compared with a reference voltage level to determine if VDD or VSS voltage level reaches the pre-determined level.

5. An apparatus for generating a bipolar output voltage from a unipolar input comprising:
at least two voltage terminals producing bipolar output voltages;
at least two first switching devices charging a first switching capacitor to a first voltage equal to said unipolar input supply voltage;
at least two second switching devices operative upon activation to charge a second switching capacitor equal to said first voltage to provide a third voltage;
a third switching capacitor receiving and storing said first voltage upon activation;
a fourth switching capacitor receiving and storing said third voltage upon activation.

6. The apparatus in claim 5 further including an oscillator for generating signals to activate said switching devices.

7. The apparatus in claim 5 wherein at least one said switching device is a transmission gate forming by a P-channel metal oxide semiconductor, an N-channel metal oxide semiconductor, and an inverter.

8. The apparatus in claim 5 wherein said switching device can be a unidirectional passive diode.

9. The apparatus in claim 5 wherein the device is integrated with other electronics in a single silicon substrate.

10. A circuit for providing a bipolar output voltage from an fixed unipolar input supply source comprising:
a plurality of first switching devices operative to charge a first transfer switching capacitor to a first voltage equal to said unipolar input supply voltage, having one said switching device selectively connecting between said supply voltage and a first end of said first switching capacitor, one said switching device selectively connecting a second end of said first switch capacitor to ground;
a plurality of second switching devices operative upon activation to charge a second switching capacitor equal to and a polarity opposite to said first voltage to provide a third voltage, having one said switching device selectively connecting between said first end of said first switching capacitor and a first end of said second switching capacitor, and one said switching device selectively connecting said second end of said second capacitor to ground;
a third switching capacitor receiving and storing said first voltage upon activation while having one said switching device selectively connecting between said first end of said switching capacitor and a first end of said third switching capacitor, whereas said second end of said third switching device connects to ground;
a fourth switching capacitor receiving and storing said third voltage upon activation.

11. The circuit of claim 10 further including an oscillator for generating signals to activate said switching devices.

12. The circuit of claim 10 wherein at least one said switching device is a transmission gate forming by a P-channel metal oxide semiconductor, an N-channel metal oxide semiconductor, and an inverter.

13. The circuit of claim 10 wherein said switching device can be a unidirectional passive diode.

14. The circuit of claim 10 wherein the device is integrated with other electronics in a single silicon substrate.
